(19) United States
(12) Patent Application Publication
(10) Pub. No.: US 2004/0144160 A1
(43) Pub. Date: Jul. 29, 2004

(54) Pad conditioning head offline testing kit

(75) Inventor: Chih-Ming Chang, Kaohsiung (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/354,629

(22) Filed: Jan. 29, 2003

(51) Int. Cl. G01M 3/02

(52) U.S. Cl. 73/37

(57) ABSTRACT

A pneumatic testing system or kit for testing the downstroke or reciprocating resistance and the presence of air leaks in an air-actuated, piston-type pad conditioning head of a pad conditioning system used in the conditioning of polishing pads for polishing semiconductor wafer substrates. The pneumatic testing system is pneumatically connected to the air-actuated piston in the conditioning head. The system is operated to drive the piston downwardly in the conditioning head while measuring the resistance imparted against the piston by the O-rings and other components in the conditioning head. A pair of switch timers connected to the circuit are capable of timing reciprocation of the piston in the conditioning head. In another application, the system is used to detect the presence of air leakages in the conditioning head.

### FIELD OF THE INVENTION

The present invention relates to disks used in the conditioning of polishing pads on chemical mechanical polishers for semiconductor wafers. More particularly, the present invention relates to a pneumatic off-line testing kit or system for testing the downstroke or reciprocating resistance of a piston in a piston-actuated pad conditioning head and detecting the presence of air leakages from the pad conditioning head.

### BACKGROUND OF THE INVENTION

Apparatus for polishing thin, flat semiconductor wafers are well-known in the art. Such apparatus normally includes a polishing head which carries a membrane for engaging and forcing a semiconductor wafer against a wetted polishing surface, such as a polishing pad. Either the pad or the polishing head is rotated and oscillates the wafer over the polishing surface. The polishing head is forced downwardly onto the polishing surface by a pressurized air system or similar arrangement. The downward force pressing the polishing head against the polishing surface can be adjusted as desired. The polishing head is typically mounted on an elongated pivoting carrier arm, which can move the pressure head between several operative positions. In one operative position, the carrier arm positions a wafer mounted on the pressure head in contact with the polishing pad. In order to remove the wafer from contact with the polishing surface, the carrier arm is first pivoted upwardly to lift the pressure head and wafer from the polishing surface. The carrier arm is then pivoted laterally to move the pressure head and wafer carried by the pressure head to an auxiliary wafer processing station. The auxiliary processing station may include, for example, a station for cleaning the wafer and/or polishing head, a wafer unload station, or a wafer load station.

More recently, chemical-mechanical polishing (CMP) apparatus has been employed in combination with a pneumatically actuated polishing head. CMP apparatus is used primarily for polishing the front face or device side of a semiconductor wafer during the fabrication of semiconductor devices on the wafer. A wafer is “planarized” or smoothed one or more times during a fabrication process in order for the top surface of the wafer to be as flat as possible. A wafer is polished by being placed on a carrier and pressed face down onto a polishing pad covered with a slurry of colloidal silica or alumina in deionized water.

A schematic of a typical CMP apparatus is shown in FIGS. 1A and 1B. The apparatus 20 for chemical mechanical polishing consists of a rotating wafer holder 14 that holds the wafer 10, the appropriate slurry 24, and a polishing pad 12 which is normally mounted to a rotating table 26 by adhesive means. The polishing pad 12 is applied to the wafer surface 22 at a specific pressure. The chemical mechanical polishing method can be used to provide a planar surface on dielectric layers, on deep and shallow trenches that are filled with polysilicon or oxide, and on various metal films.

CMP polishing results from a combination of chemical and mechanical effects. A possible mechanism for the CMP process involves the formation of a chemically altered layer at the surface of the material being polished. The layer is mechanically removed from the underlying bulk material. An altered layer is then regrown on the surface while the process is repeated again. For instance, in metal polishing, a metal oxide may be formed and removed separately.

A polishing pad is typically constructed in two layers overlying a platen with the resilient layer as the outer layer of the pad. The layers are typically made of polyurethane and may include a filler for controlling the dimensional stability of the layers. The polishing pad is usually several times the diameter of a wafer and the wafer is kept off-center on the pad to prevent polishing a non-planar surface onto the wafer. The wafer is also rotated to prevent polishing a taper into the wafer. Although the axis of rotation of the wafer and the axis of rotation of the pad are not collinear, the axes must be parallel.

In a CMP head, large variations in the removal rate, or polishing rate, across the whole wafer area are frequently observed. A thickness variation across the wafer is therefore produced as a major cause for wafer non-uniformity. In the improved CMP head design, even though a pneumatic system for forcing the wafer surface onto a polishing pad is used, the system cannot selectively apply different pressures at different locations on the surface of the wafer. This effect is shown in FIG. 1C, i.e. in a profilometer trace obtained on an 8-inch wafer. The thickness difference between the highest point and the lowest point on the wafer is almost 2,000 angstroms, resulting in a standard deviation of 472 angstroms, or 6.26%. The curve shown in FIG. 1C is plotted with the removal rates in the vertical axis and the distance from the center of the wafer in the horizontal axis. It is seen that the removal rates obtained at the edge portions of the wafer are substantially higher than the removal rates at or near the center of the wafer. The thickness uniformity on the resulting wafer after the CMP process is poor.

The polishing pad 12 is a consumable item used in a semiconductor wafer fabrication process. Under normal wafer fabrication conditions, the polishing pad is replaced after about 12 hours of usage. Polishing pads may be hard, incompressible pads or soft pads. For oxide polishing, hard and stiffer pads are generally used to achieve planarity. Softer pads are generally used in other polishing processes to achieve improved uniformity and smooth surfaces. The hard pads and the soft pads may also be combined in an arrangement of stacked pads for customized applications.

A problem frequently encountered in the use of polishing pads in oxide planarization is the rapid deterioration in oxide polishing rates with successive wafers. The cause for the deterioration is known as “pad glazing”, wherein the surface of a polishing pad becomes smooth such that slurry is no longer held in between the fibers of the pad. This physical phenomenon on the pad surface is not caused by any chemical reactions between the pad and the slurry.

To remedy the pad glazing effect, numerous techniques of pad conditioning or scrubbing have been proposed to regenerate and restore the pad surface and thereby restore the polishing rates of the pad. The pad conditioning techniques include the use of silicon carbide particles, diamond emery paper, blade or knife for scraping or scoring the polishing pad surface. The goal of the conditioning process is to remove polishing debris from the pad surface and re-open pores in the pad by forming micro-scratches in the surface of the pad for improved pad lifetime. The pad conditioning process can be carried out either during a polishing process, i.e. known as concurrent conditioning, or after a polishing process.

Referring next to FIG. 2, a conventional CMP apparatus 50 includes a conditioning head 52 fitted with a conditioning disk 68, which is formed by embedding or encapsulating diamond particles in nickel coated on the surface of the conditioning disk 68; a polishing pad 56; and a slurry delivery arm 54 positioned over the polishing pad 56. The conditioning head 52 is mounted on a conditioning arm 58 which is extended over the top of the polishing pad 56 for making a sweeping motion across the entire surface of the polishing pad 56. The slurry delivery arm 54 is equipped with slurry dispensing nozzles 62 which are used for dispensing a slurry solution on the top surface 60 of the polishing pad 56. Surface grooves 64 are further provided in the top surface 60 to facilitate even distribution of the slurry solution and to help entrapping undesirable particles that are generated by coagulated slurry solution or any other foreign particles which have fallen on top of the polishing pad 56 during a polishing process. The surface grooves 64, while serving an important function of distributing the slurry, also presents a processing problem when the pad surface 60 gradually wears out after prolonged use.

Recently, a pad conditioning arm 102 having a new type of pad conditioning head 101, shown in FIGS. 3 and 4, has been designed for existing Mirra-type polishing pad conditioning systems. The pad conditioning head 101 includes a housing 103 which is typically mounted on a head support arm 130. A cylindrical core wall 104 is mounted inside the housing 103, and a cylindrical piston 107 is vertically slidably mounted between the inner surface of the housing 103 and the outer surface of the core wall 104. An upper air cavity 108 is defined above the piston 107, and a lower air cavity 111 is defined beneath the piston 107. At least one upper cavity air opening 128 communicates with the upper air cavity 108 for the introduction of air into the upper air cavity 108 and moving the piston 107 downwardly in the housing 103. Similarly, at least one lower cavity air opening (not shown) communicates with the lower air cavity 111 for the introduction of air into the lower air cavity 111 and moving the piston 107 upwardly in the housing 103. An outside O-ring 110 is interposed between the piston 107 and the housing 103. A magnetic ring 109 encircles the piston 107 and is disposed in contact with the inner surface of the housing 103. A position-sensing proximity switch 112 is provided in the housing 103, in magnetic contact with the magnetic ring 109, for sensing the vertical position of the piston 107 in the housing 103, as hereinafter further described. An inside O-ring 113 is typically interposed between the inner surface of the piston 107 and the outer surface of the core wall 104.

A cylindrical hub 115 having a central hub bore 116 is mounted inside the core wall 104, with a ball bearing 118 and a needle bearing 121 typically interposed between the outer surface of the hub 115 and the inner surface of the core wall 104. A belt gear 117, which receives a drive belt 123 engaged by a driving mechanism (not shown), is mounted on the upper end of the hub 115. A shaft 120 extends downwardly through the hub bore 116, and a cylindrical bearing 119 is interposed between the shaft 120 and the hub 115. A travel housing 122 is mounted on the bottom end of the shaft 120. A conditioning disk holder 125 is attached to the travel housing 122 for supporting a conditioning disk 126 on the pad conditioning head 101. The conditioning disk 126 typically threads into the conditioning disk holder 125, in conventional fashion. A travel housing bearing 124 is interposed between the piston 107 and the travel housing 122.

In operation of the pad conditioning head 101, the conditioning disk 126 is typically threadably attached to the conditioning disk holder 125 preparatory to conditioning a CMP pad 132. Rotation is transmitted from the belt gear 117 to the conditioning disk 126 through the hub 115, the cylindrical bearing 119, the shaft 120, the travel housing 122 and the conditioning disk holder 125, respectively. Upon introduction of pressurized air into the upper air cavity 108, the piston 107 slides downwardly in the housing 103 and pushes the travel housing bearing 124, the travel housing 122, the conditioning disk holder 125 and the conditioning disk 126 downwardly, such that the conditioning disk 126 is simultaneously rotated and pressed against the CMP pad 132 to be conditioned. Pressure of the conditioning disk 126 against the CMP pad 132 may be decreased or terminated by introducing pressurized air into the lower air cavity 111, such that the piston 107 moves upwardly in the housing 103 and raises the conditioning disk 126 through the housing bearing 124, the travel housing 122 and the conditioning disk holder 125. The proximity switch 112 continually senses the position of the magnetic ring 109 on the piston 107 and feeds this information back to a timer control box 134, as shown in FIG. 10, to vary the pressure exerted against the CMP pad 132 by the conditioning disk 126 as a function of time according to the conditioning needs of the CMP pad 132.

Typically, the cylinder-type pad conditioning head 101 is used to replace the diaphragm-type pad conditioning head which is currently in widespread usage to polish semiconductor wafers, since the latter tends toward frequent breakdown and other problems which must be fixed often. After installation, and during routine periodic maintenance, it is beneficial to test the cylinder-type pad conditioning head 101 as to both resistance imparted by the outside O-ring 110 and the inside O-ring 113 to the downstroke and reciprocating action of the piston 107 inside the housing 103, as well as leakage of air from the upper air cavity 108, the lower air cavity 111 or both, since both resistance and air leakage can adversely affect the magnitude of pressure that the pad conditioning head 101 is capable of applying to a wafer substrate for sufficient polishing of the substrate. Accordingly, a testing system or kit is needed for the post-installation and periodic maintenance (PM) testing of the cylinder-type Mirra pad conditioning head 101.

An object of the present invention is to provide a system or kit for testing a cylinder-type pad conditioning head for conditioning a polishing pad used in the conditioning of semiconductor wafer substrates.

Another object of the present invention is to provide a system or kit for testing a cylinder-type pad conditioning head as to resistance imparted against the conditioning head piston during downstroke of the piston inside the head housing.

Still another object of the present invention is to provide a system or kit for testing a cylinder-type pad conditioning head as to the presence of air leaks in the pneumatic pressure application system of the pad conditioning head.

Yet another object of the present invention is to provide a system or kit for testing a Mirra cylinder-type pad conditioning head as to both the resistance imparted against the conditioning head piston during downstroke of the piston inside the head housing and as to the presence of air leaks in the pneumatic pressure application system of the pad conditioning head.

A still further object of the present invention is to provide a pad conditioning head testing system or kit which includes at least one arm mount platform for receiving a pad conditioning arm having a piston-type pad conditioning head and is adapted for testing the downstroke resistance and/or presence of air leakages in the conditioning head.

### SUMMARY OF THE INVENTION

In accordance with these and other objects and advantages, the present invention is generally directed to a pneumatic testing system or kit for testing the downstroke or reciprocating resistance and the presence of air leaks in an air-actuated, piston-type pad conditioning head of a pad conditioning system used in the conditioning of polishing pads for polishing semiconductor wafer substrates. The pneumatic testing system is pneumatically connected to the air-actuated piston in the conditioning head. The system is operated to drive the piston downwardly in the conditioning head while measuring the resistance imparted against the piston by the O-rings and other components in the conditioning head. A pair of switch timers connected to the circuit are capable of timing reciprocation of the piston in the conditioning head. In another application, the system is used to detect the presence of air leakages in the conditioning head. At least one pad conditioning arm having the conditioning head may be placed typically in a maintenance tool which is equipped with the pneumatic testing system for testing and maintenance of the conditioning head.

### BRIEF DESCRIPTION OF THE DRAWINGS

The invention will now be described, by way of example, with reference to the accompanying drawings, in which:

FIG. 1A is a cross-sectional view of a conventional chemical mechanical polishing apparatus;

FIG. 1B is an enlarged, cross-sectional view of a section of a wafer and polishing pad with a slurry solution therein between, in a conventional disk polishing operation;

FIG. 1C is a graph illustrating the changes in removal rates as a function of distance on a wafer after a polishing pad is repeatedly used;

FIG. 2 is a perspective view of a conventional CMP polishing pad with a slurry dispensing arm and a conditioning disk positioned on top;

FIG. 3 is a cross-sectional view of a cylinder-type pad conditioning head suitable for implementation of the present invention;

FIG. 4 is a schematic view of a pad conditioning arm having the cylinder-type pad conditioning head shown in FIG. 3;

FIG. 5 is a schematic diagram of a pneumatic testing system of the present invention;

FIG. 6 is an electrical diagram for the switch timers and solenoid valve components of the pneumatic testing system of FIG. 5;

FIG. 7 is a front view of a pad conditioning arm maintenance tool of the present invention;

FIG. 8 is a side view of the pad conditioning arm maintenance tool of FIG. 7;

FIG. 9 is a top view of the pad conditioning arm maintenance tool; and

FIG. 10 is a side view of a pad conditioning arm, mounted on the pad conditioning arm maintenance tool of FIGS. 7-9.

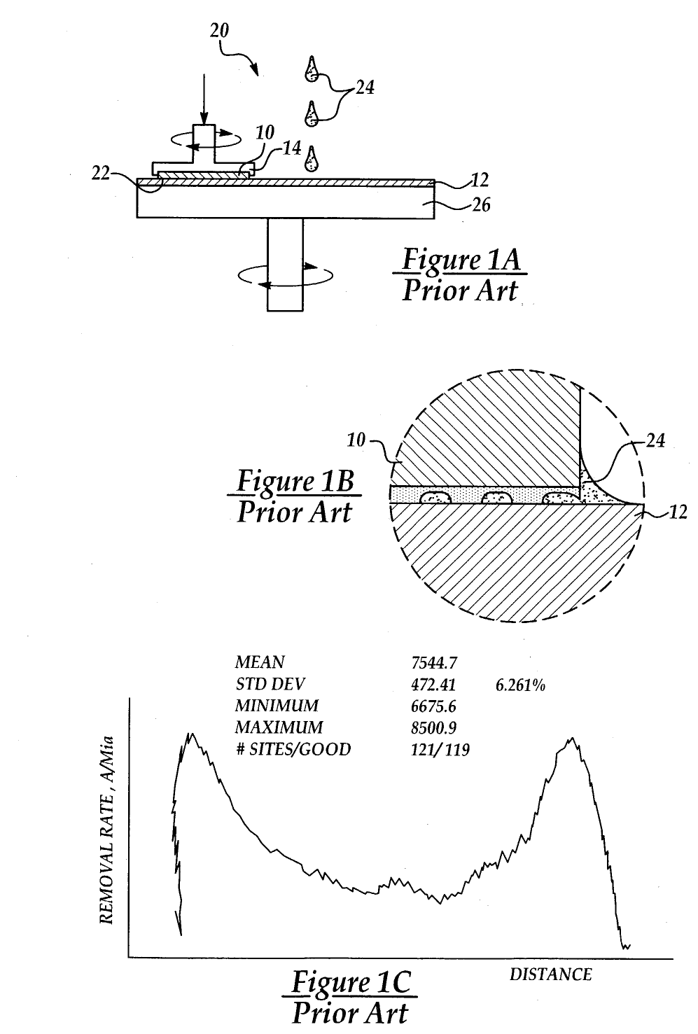

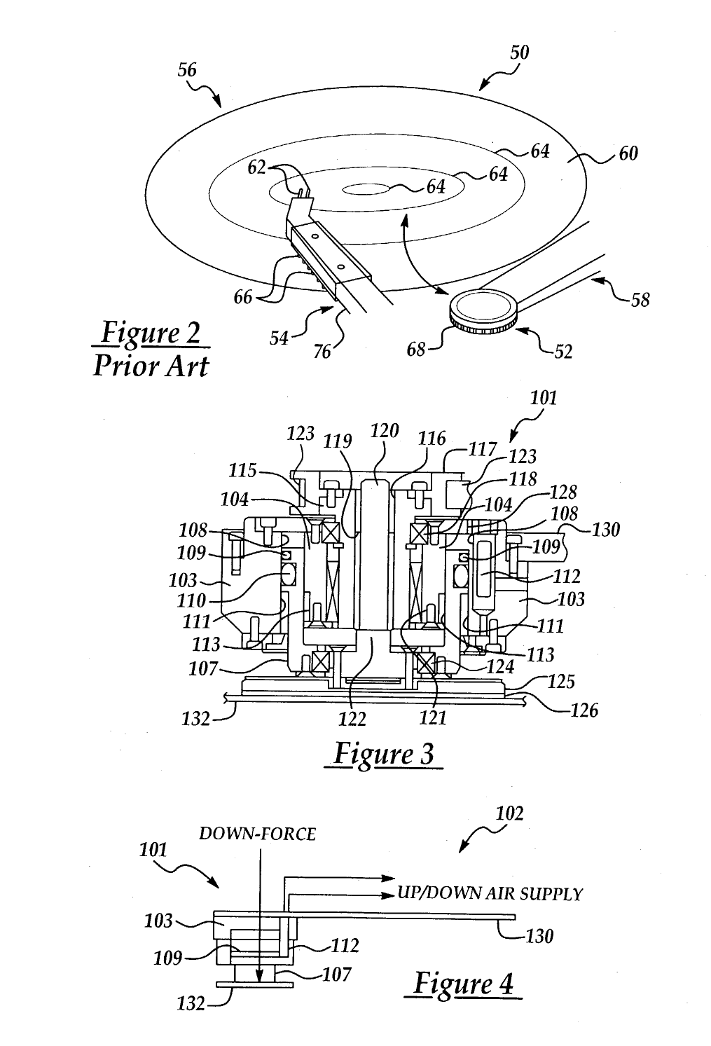

### DESCRIPTION OF THE PREFERRED EMBODIMENTS

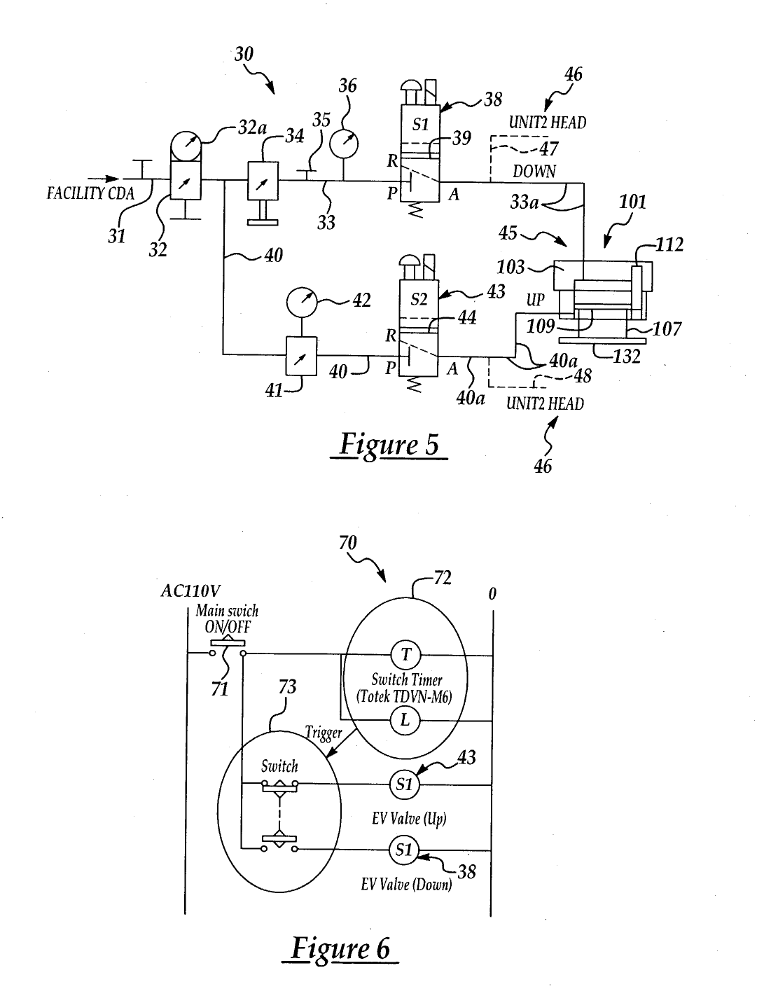

Referring initially to FIG. 5, a pneumatic testing kit or system 30 in accordance with the present invention includes an air inlet line 31 which receives a stream of clean, dry air (CDA) from a standard CDA source in the semiconductor fabrication facility. A system pressure adjustment valve 32, fitted with a main pressure gauge 32a, is provided in the air inlet line 31. A piston “down” line 33 and a piston “up” line 40 branch from the air inlet line 31.

A “down” speed adjustment valve 34 is provided in the piston “down’ line 33, and a manual valve 35 is provided in the piston “down” line 33 downstream of the “down” speed adjustment valve 34. A “down” air pressure gauge 36 is provided downstream of the manual valve 34. A “down” solenoid valve 38, having a pressure vent 39, is provided downstream of the “down” air pressure gauge 36. The downstream segment 33a of the piston 37 down” line 33, extending from the outlet of the “down” solenoid valve 38, is provided in pneumatic communication with the upper air cavity 108 (FIG. 3) of the pad conditioning head 101. Assuming that the pad conditioning head 101 is a part of a first pad conditioning unit 45, the pad conditioning head 101 of a second pad conditioning unit 46 may be pneumatically connected, via a piston “down” line 47, to the downstream segment 33a in parallel with the pad conditioning head 101 of the first pad conditioning unit 45.

As further shown in FIG. 5, an “up” speed adjustment valve 41, fitted with an “up” air pressure gauge 42, is provided in the piston “up” line 40. An “up” solenoid valve 43, having a pressure vent 44, is provided in the piston “up” line 40, downstream of the “up” speed adjustment valve 41. A downstream segment 40a of the piston “up” line 40 extends from the outlet of the “up” solenoid valve 43 and is provided in pneumatic communication with the lower air cavity 111 (FIG. 3) of the pad conditioning head 101. Assuming that the pad conditioning head 101 is a part of the first pad conditioning unit 45, the pad conditioning head 101 of the second pad conditioning unit 46 may be pneumatically connected, via a piston “up” line 48, to the downstream segment 40a in parallel with the pad conditioning head 101 of the first pad conditioning unit 45.

Referring next to FIG. 6, an electrical schematic 70 for the pneumatic testing system 30 includes an on/off switch 71 that is applied across an AC electrical potential of typically 110 volts. The electrical schematic 70 further includes a switch timer 72 that is electrically connected to an SV (solenoid valve) switch 73 which controls the “down” solenoid valve 38 and the “up” solenoid valve 43.

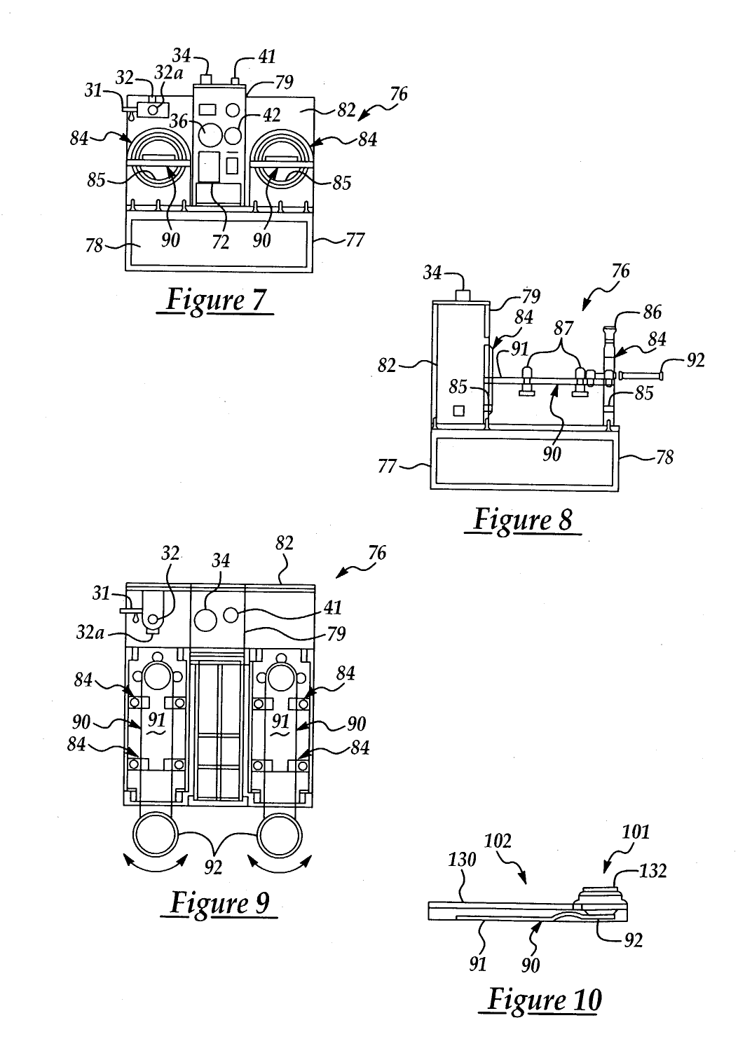

Referring next to FIGS. 7-10, the pneumatic testing system 30 may be provided on a maintenance tool 76 for testing and maintenance of the pad conditioning heads 101 of the respective first pad conditioning unit 45 and second pad conditioning unit 46. The maintenance tool 76 includes a base 77, which may contain an extendible drawer 78. A back panel 82 extends from the base 77, and an instrument panel 79 is provided in front of the rear panel 82. As shown in FIG. 9, a pair of spaced-apart platform rotation collars 84, each having a platform opening 85, is provided on each side of the base 77. An elongated arm mount platform 90 extends through the registering platform openings 85 of the corresponding pair of platform rotation collars 84, and rotatably engages the platform rotation collars 84 according to the knowledge of those skilled in the art. Each arm mount platform 90 typically includes a body portion 91 and a head portion 92 extending from the body portion 91. Each arm mount platform 90 is capable of rotating longitudinally in the platform openings 85 of the platform rotation collars 84. As shown in FIG. 8, a pair of arm lock bolts 87 is typically provided in the body portion 91 of each arm mount platform 90 for removably mounting each pad conditioning arm 102 to the corresponding arm mount platform 90. A rotation lock bolt 86 extends through at least one of the platform rotation collars 84 for engaging the pad conditioning arm 102 mounted on the corresponding arm mount platform 90 and preventing rotation of the arm mount platform 90 during testing or maintenance of the pad conditioning head 101, as desired and hereinafter further described.

The various control and indicator components of the pneumatic testing system 30 heretofore described with respect to FIG. 5 are typically provided on the maintenance tool 76. Accordingly, the air inlet line 31 and the system pressure adjust valve 32, having the main pressure gauge 32a, are typically mounted on the back panel 82. The “down” speed adjustment valve 34 and the “up” speed adjustment valve 41 are typically mounted on the horizontal portion of the instrument panel 79. The “down” air pressure gauge 36 and the “up” air pressure gauge 42 may be provided in adjacent relationship to each other on the vertical portion of the instrument panel 79, and the switch timer 72 may be provided on the instrument panel 79, beneath the “down” air pressure gauge 36. However, it is understood that these control and indicator components of the pneumatic testing system 30 may be provided in alternative locations on the maintenance tool 76, as desired.

Referring again to FIGS. 5-10, in typical operation of the pneumatic testing system 30, the pad conditioning arm 102 of the first pad conditioning unit 45 and the pad conditioning arm 102 of the second pad conditioning unit 46 may be removably mounted on the respective arm mount platforms 90 of the maintenance tool 76, and alternately tested as to downstroke or reciprocating resistance and air leakage. This is accomplished typically by initially positioning the pad conditioning arms 102 on the respective arm mount platforms 90 and then threading the arm lock bolts 87 (FIG. 8) of each arm mount platform 90 into respective threaded lock bolt openings (not shown) provided in the head support arm 130 of the pad conditioning arm 102. Next, the rotation lock bolts 86 may be threaded against the respective pad conditioning arms 102 in order to prevent longitudinal rotation of the arm mount platforms 90 and pad conditioning arms 102 in the respective pairs of platform rotation collars 84, as desired.

Referring again to FIGS. 3 and 4, the pneumatic testing system 30 is used to both measure the downstroke resistance of the piston 107 inside the housing 103 of the pad conditioning head 101 and detect and measure leakage of air from the upper air cavity 108 or lower air cavity 111 during reciprocation of the piston 107 inside the housing 103. Both of these parameters tend to affect the magnitude of pressure that the conditioning disk 126 is capable of applying to the CMP pad 132 to achieve optimum polishing of the CMP pad 132. Excessive downstroke resistance of the piston 107 with respect to the housing 103 may indicate excessive grinding of the O-rings 110 and 113, respectively, for example, and enable facility personnel to replace the O-rings 110 and 113 in order to reduce the downstroke resistance. Likewise, leakage of air from the upper air cavity 108 reduces the magnitude of pressure that the conditioning disk 126 is capable of applying to the CMP pad 132.

The downstroke resistance of the piston 107 with respect to the housing 103 is measured, as follows. First, the system pressure adjust valve 32 is used to set the system air pressure, such as 5 psi, as indicated by the main pressure gauge 32a. Next, the switch timer 72 is set to control the timing for reciprocation of the piston 107 in the housing 103. The reciprocation speed of the piston 107 may be adjusted using the “down” speed adjustment valve 34 and the “up” speed adjustment valve 41. Accordingly, the switch timer 72 initially triggers the SV switch 73 to actuate the “up” solenoid valve 43, which facilitates the passage of air from the piston “up” line 40 to the downstroke segment 40a and into the lower air cavity 111 (FIG. 3) of the pad conditioning head 101. The increased air pressure in the lower air cavity 111 drives the piston 107 upwardly in the housing 103, as the piston 107 drives air from the upper air cavity 108, through the downstream segment 33a and out the pressure vent 39 of the “down” solenoid valve 38. Next, the switch timer 72 triggers the SV switch 73 to actuate the “down” solenoid valve 38, which facilitates the passage of air from the piston “down” line 33 to the downstroke segment 33a and into the upper air cavity 108 of the pad conditioning head 101. The increased air pressure in the upper air cavity 108 drives the piston 107 downwardly in the housing 103, as the piston 107 drives air from the lower air cavity 111, through the downstream segment 40a and out the pressure vent 44 of the “down” solenoid valve 43. The “down” air pressure gauge 36 indicates the downstroke resistance, in psi, of the piston 107 in the housing 103. Accordingly, in the event that the downstroke resistance exceeds the system air pressure, as indicated on the main pressure gauge 32a, by a specified value, such as by about 50%, for example, then corrective measures may be taken to replace either or both of the O-rings 110, 113, and/or other components in the pad conditioning head 101, in order to reduce the downstroke resistance and optimize the down pressure applied by the conditioning disk 126 against the CMP pad 132.

The pad conditioning head 101 is tested as to the presence of air leakages, in the following manner. First, the switch timer 72 is set according to the desired leakage rate parameters for the leakage test. For example, if the rate of air leakage is to be measured in psi/minute, then the switch timer 72 is set to reciprocate the piston 107 in the housing 103 every two minutes (downwardly one minute and upwardly the next minute) Next, the system pressure adjust valve 32 is used to set the system air pressure, such as 5 psi, as indicated by the main pressure gauge 32a. After the switch timer 72 causes the “down” solenoid valve 38 to move the piston 107 downwardly in the housing 103, the manual valve 35 is closed, after which the switch timer 72 causes the “up” solenoid valve 43 to move the piston 107 upwardly in the housing 103. In the event that none of the pressurized air leaks from the upper air cavity 108 or lower air cavity 111 of the pad conditioning head 101, the air pressure as indicated by the “up” air pressure gauge 42 equals the system air pressure as indicated by the main pressure gauge 32a, which is, in this case, 5 psi. On the other hand, in the event that air leaks from the upper air cavity 108 and/or the lower air cavity 111, the air pressure as indicated by the “up” air pressure gauge 42 is lower than the system air pressure as indicated by the main pressure gauge 32a. In that case, corrective repair measures may be taken to adequately seal the upper air cavity 108 and/or the lower air cavity 111 prior to beginning or resuming use of the pad conditioning arm 102. Referring again to FIG. 9, it will be appreciated by those skilled in the art that the facility for longitudinally rotating the arm mount platforms 90 and the respective attached pad conditioning arms 102 on the maintenance tool 76 provides versatility in the repair and maintenance of the pad conditioning arms 102.

While the preferred embodiments of the invention have been described above, it will be recognized and understood that various modifications can be made in the invention and the appended claims are intended to cover all such modifications which may fall within the spirit and scope of the invention.

What is claimed is:

1. A system for testing a pad conditioning head having a housing, a piston slidably disposed in the housing and upper and lower air cavities for receiving air and reciprocating the piston in the housing, comprising:
a first pressure gauge for receiving air and indicating a system air pressure;
a first valve provided in pneumatic communication with said first pressure gauge for distributing the air to the upper air cavity and driving the piston downwardly in the housing;
a second valve provided in pneumatic communication with said first pressure gauge for distributing the air to the lower air cavity and driving the piston upwardly in the housing; and
a second pressure gauge provided in pneumatic communication with one of said first valve and said second valve for indicating an air pressure corresponding to a resistance of the piston in the housing.

2. The system of claim 1 further comprising a “down” speed adjustment valve provided between said first pressure gauge and said first valve for driving the piston downwardly at a selected speed in the housing and an “up” speed adjustment valve provided between said first pressure gauge and said second valve for driving the piston upwardly at a selected speed in the housing.

3. The system of claim 1 further comprising a switch timer operably connected to said first valve and said second valve for timing reciprocation of the piston in the pad conditioning head.

4. The system of claim 3 further comprising a “down” speed adjustment valve provided between said first pressure gauge and said first valve for driving the piston downwardly at a selected speed in the housing and an “up” speed adjustment valve provided between said first pressure gauge and said second valve for driving the piston upwardly at a selected speed in the housing.

5. The system of claim 1 wherein said second pressure gauge comprises a “down” pressure gauge provided in pneumatic communication with said first valve and further comprising an “up” pressure gauge provided in pneumatic communication with said second valve for indicating an air pressure corresponding to leakage of air from the housing.

6. The system of claim 5 further comprising a “down” speed adjustment valve provided between said first pressure gauge and said first valve for driving the piston downwardly at a selected speed in the housing and an “up” speed adjustment valve provided between said first pressure gauge and said second valve for driving the piston upwardly at a selected speed in the housing.

7. The system of claim 5 further comprising a switch timer operably connected to said first valve and said second valve for timing reciprocation of the piston in the pad conditioning head.

8. The system of claim 7 further comprising a “down” speed adjustment valve provided between said first pressure gauge and said first valve for driving the piston downwardly at a selected speed in the housing and an “up” speed adjustment valve provided between said first pressure gauge and said second valve for driving the piston upwardly at a selected speed in the housing.

9. A method of testing a resistance of a piston in a pad conditioning head having upper and lower air cavities, comprising the steps of:
providing a system comprising a main pressure gauge, an air pressure gauge pneumatically connected to said main pressure gauge and a valve pneumatically connected to said air pressure gauge;
providing said valve in pneumatic communication with the pad conditioning head;
flowing air through said main pressure gauge, said air pressure gauge and said valve at a system pressure indicated by said main pressure gauge; and
indicating an air pressure on said air pressure gauge, wherein said air pressure exceeds said system pressure when the resistance imparted to the piston in the pad conditioning head is excessive.

10. The method of claim 9 wherein said providing said valve in pneumatic communication with the pad conditioning head comprises the step of providing said valve in pneumatic communication with the upper air cavity, and wherein said system further comprises a second air pressure gauge provided in pneumatic communication with said main pressure gauge and a second valve pneumatically connected to said second air pressure gauge, and further comprising the step of pneumatically connecting said second valve to the lower air cavity.

11. The method of claim 10 further comprising the step of testing leakage of air from the pad conditioning head by displacing the piston downwardly in the pad conditioning head; terminating flow of air from said main pressure gauge to said valve; flowing the air from said main pressure gauge, through said second air pressure gauge and said second valve and to the lower air cavity to displace the piston upwardly in the pad conditioning head and indicating a second air pressure on said second air pressure gauge, wherein said second air pressure is less than said system pressure when the air leaks from the pad conditioning head.

12. The system of claim 9 wherein said air pressure exceeds said system pressure by at least about 50% when the resistance imparted to the piston in the pad conditioning head is excessive.

13. The system of claim 12 wherein said providing said valve in pneumatic communication with the pad conditioning head comprises the step of providing said valve in pneumatic communication with the upper air cavity, and wherein said system further comprises a second air pressure gauge provided in pneumatic communication with said main pressure gauge and a second valve pneumatically connected to said second air pressure gauge, and further comprising the step of pneumatically connecting said second valve to the lower air cavity.

14. The system of claim 13 further comprising the step of testing leakage of air from the pad conditioning head by displacing the piston downwardly in the pad conditioning head; terminating flow of air from said main pressure gauge to said valve; flowing the air from said main pressure gauge, through said second air pressure gauge and said second valve and to the lower air cavity to displace the piston upwardly in the pad conditioning head and indicating a second air pressure on said second air pressure gauge, wherein said second air pressure is less than said system pressure when the air leaks from the pad conditioning head.

15. A maintenance tool for testing and maintaining at least one pad conditioning arm having a pad conditioning head including a piston and upper and lower air cavities for receiving air and reciprocating the piston, comprising:
a base;
at least one arm mount platform carried by said base for receiving the at least one pad conditioning arm, respectively; and
a pneumatic testing system carried by said base for testing said pad conditioning head.

16. The maintenance tool of claim 15 wherein said at least one arm mount platform comprises a pair of arm mount platforms.

17. The maintenance tool of claim 15 wherein said at least one arm mount platform is rotatably carried by said base.

18. The maintenance tool of claim 17 wherein said at least one arm mount platform comprises a pair of arm mount platforms.

19. The maintenance tool of claim 15 further comprising an instrument panel carried by said base and a back panel carried by said base adjacent to said instrument panel.

20. The maintenance tool of claim 19 wherein said pneumatic testing system comprises an air inlet line; a system pressure adjusting valve having a main pressure gauge carried by said back panel and pneumatically connected to said air inlet line; a “down” air pressure gauge provided on said instrument panel and pneumatically connected to said main pressure gauge; a “down” solenoid valve pneumatically connected to said “down” air pressure gauge for pneumatic connection to the upper air cavity and driving the piston downwardly in the pad conditioning head; an “up” air pressure gauge provided on said instrument panel and pneumatically connected to said system pressure adjusting valve; and an “up” solenoid valve pneumatically connected to said “up” air pressure gauge for pneumatic connection to the lower air cavity and driving the piston upwardly in the pad conditioning head.
